(19) United States
(12) Patent Application Publication
(10) Pub. No.: US 2026/0306335 A1
(43) Pub. Date: Oct. 8, 2026

(54) SURGICAL TABLE LEG ACCESSORY ATTACHMENT ASSEMBLY

(71) Applicant: American Sterilizer Company, Mentor, OH (US)

(72) Inventor: Michael E. Koerth, Newbury, OH (US)

(73) Assignee: American Sterilizer Company, Mentor, OH (US)

(21) Appl. No.: 19/481,566

(22) PCT Filed: May 15, 2024
(86) PCT No.: PCT/US2024/029370

§ 371 Date: Nov. 5, 2025

Related U.S. Application Data
(60) Provisional application No. 63/466,780, filed on May 16, 2023.

(51) Int. Cl. A61G 13/12

(52) U.S. Cl. CPC A61G 13/1285; A61G 13/1245

(57) ABSTRACT

Latching mechanism for leg accessory of surgical table includes interlocking first and second movable components, an actuating lever, an attachment pin, and a biasing member. The actuating lever is connected to the first movable component such that pivoting of the actuating lever causes rotation of the first movable component. The attachment pin removably attaches the leg accessory to the surgical table, is connected to the second movable component to rotate as the second movable component rotates, and includes an engagement surface moveable between a first position and a second position in response to rotation of the attachment pin, for respectively engaging and disengaging a retaining surface in the surgical table. The biasing member biases the attachment pin toward the first position. The actuating lever is pivotable against the bias of the biasing member to move the attachment pin and engagement surface thereof from the first position to the second position.

### CLAIM OF PRIORITY AND CROSS-REFERENCE TO RELATED APPLICATIONS

This application claims priority to U.S. Provisional Patent Application Ser. No. 63/466,780, filed on May 16, 2023, entitled “SURGICAL TABLE LEG ACCESSORY ATTACHMENT ASSEMBLY,” which is incorporated by reference herein in its entirety.

### FIELD OF INVENTION

The present application relates generally to a surgical table leg accessory attachment assembly to selectively attach a leg accessory to a surgical table.

### BACKGROUND

Surgical tables can include one or more leg accessory components that are selectively attachable to the surgical table to support the legs of a patient. Each leg accessory may be equipped with a latching mechanism to attach and detach the leg accessory to a respective receptacle block of the surgical table.

Existing latching mechanisms have various shortcomings and drawbacks. For example, some latching mechanisms consume too large of a volumetric footprint. In some applications, the volumetric footprint projects inward under a radiolucent leg accessory so as to obstruct an x-ray path that would otherwise pass through the leg accessory. Some latch mechanisms may employ small size intricate components that are prone to break and/or require a large quantity of components, increasing complexity and cost.

Accordingly, there remains a need for further contributions in this area of technology.

### SUMMARY OF INVENTION

The following is a summary of subject matter that is described in greater detail herein. This summary is not intended to be limiting as to the scope of the claims. According to one aspect of the invention, a latching mechanism for selectively latching and unlatching an accessory of a surgical table relative to a retaining surface of the surgical table includes interlocking first and second movable components, wherein the first movable component and the second movable component are arranged such that movement of the first movable component in a first direction causes rotation of the second movable component in a second rotational direction; an actuating device connected to the first movable component such that moving of the actuating device causes movement of the first movable component; an attachment pin for removably attaching the leg accessory to the surgical table, wherein the attachment pin is connected to the second movable component to rotate as the second movable component rotates, wherein the attachment pin includes an engagement surface moveable between a first position and a second position in response to rotation of the attachment pin, for respectively engaging and disengaging the retaining surface in the surgical table; and a biasing member configured to bias the attachment pin including the engagement surface thereof toward the first position, wherein the actuating device is movable against the bias of the biasing member to move the attachment pin and engagement surface thereof from the first position to the second position.

Embodiments of the invention may include one or more of the following additional features separately or in combination.

The first movable component may have a first body portion that rotates in a first plane, and the second movable component may have a second body portion that rotates in a second plane that is different from the first plane.

The first movable component may have a first body portion that rotates about a first axis, and the second movable component may have a second body portion that rotates about a second axis that is parallel to the first axis, and the first body portion and the second body portion may partially overlap so as to be stacked in an axial direction.

The first movable component may include a pin extending axially from a surface of the first body portion of the first movable component, wherein the pin of the first movable component moves in the second plane of the second body portion of the second movable component.

The first movable component may include a pin, and the second movable component may include a notch therein, and the pin and the notch may be configured such that rotation of the first and second movable components causes the pin to move radially in the notch relative to a rotation axis of the second movable component.

The first movable component may include a crank member having a crank pin, and the second movable component may include a driven member having a notch therein as a radial slot within which the crank pin slides as the crank member and driven member rotate.

The first movable component may include a first body portion and a pin extending axially from a surface of the first body portion, and the second movable component may have a fork shape and include a pair of arms configured to engage the pin such that rotation of the first movable component causes the pin to engage the pair of arms to rotate the fork shape second movable component.

The biasing member may be a torsion spring.

The torsion spring may be attached to the first movable component and may be configured to bias the attachment pin toward the first position via the interlock between the first and second movable components.

The latching mechanism may further include a housing having a housing body with a recess shaped to rotatably support the first movable component and the second movable component; and a cover to cover the housing body and to axially retain the first movable component and the second movable component in the housing body.

The actuating lever may be connected to the first movable component by a drive shaft, and the drive shaft may extend through an aperture in the cover such that the actuating lever can be arranged on an opposing side of the cover as the first movable component, and the attachment pin may be connected to the second movable component by a mechanical latch shaft that extends through an opening in the housing.

The biasing member may be a torsion spring, and the recess may be further shaped to engage a first leg of the torsion spring, and a second leg of the torsion spring may be configured to extend into a spring opening on the first movable component.

The first movable component may be configured to rotate about a first rotational axis, and the second movable component may be configured to rotate about a second rotational axis, and the first rotational axis and the second rotational axis may be parallel and offset from one another.

The latching mechanism may be in combination with a leg accessory and a surgical table including a retaining surface, wherein the latching mechanism is connected to the leg accessory, and wherein in the first position the engagement surface of the attachment pin engages the retaining surface in the surgical table to attach the leg accessory to the surgical table, and wherein in the second position the engagement surface is positioned away from the retaining surface in the surgical table to enable removal of the leg accessory from the surgical table.

According to another aspect of the invention, a surgical table includes a base; a column extending from the base along a column axis; a plurality of body support sections arranged at an end of the column; and a leg accessory removably attachable to a receptacle block in at least one of the column or the plurality of body support sections, and the leg accessory includes: an attachment pin for removably attaching the leg accessory to the receptacle block, wherein the attachment pin includes an engagement surface configured to engage a corresponding retaining surface in the receptacle block in a first position to attach the leg accessory to the receptacle block, wherein in a second position the engagement surface is positioned away from the retaining surface to enable removal of the leg accessory from the receptacle block; and an actuating lever configured to move the attachment pin between the first position and the second position as the actuating lever rotates about a lever rotation axis, wherein the actuating lever includes a handle that extends along a handle axis, wherein the handle protrudes downward at an angle relative to the lever rotation axis, wherein the handle axis is at a first angle relative to the column axis in the first position, wherein the handle axis is at a second angle relative to the column axis in the second position, wherein the first angle is different from the second angle.

Embodiments of the invention may include one or more of the following additional features separately or in combination.

The handle axis may be configured to be parallel to the column axis when the attachment pin is in the first position, and further the handle axis may be configured to be at an angle to the column axis when the attachment pin is in the second position.

The attachment pin may be configured to rotate about pin rotation axis between the first position and the second position, wherein the lever rotation axis and the pin rotation axis are offset from each other.

The handle axis may be configured to be parallel to the column axis in the first position.

The handle axis may be configured to be angled away from the column axis of the column in the second position.

The surgical table may further include a second leg accessory removably attachable to a second receptacle block in at least one of the column or the plurality of body support sections, wherein the second leg accessory includes: a second attachment pin for removably attaching the second leg accessory to the second receptacle block, wherein the second attachment pin includes a second engagement surface configured to engage a second corresponding retaining surface in the second receptacle block in a third position to attach the second leg accessory to the receptacle block, wherein in a fourth position the second engagement surface is positioned away from the second retaining surface to enable removal of the second leg accessory from the second receptacle block; and a second actuating lever configured to move the second attachment pin as the second actuating lever rotates about a second lever rotation axis, wherein the second actuating lever includes a second handle that extends along a second handle axis, wherein the second handle protrudes downward at an angle relative to the second lever rotation axis, wherein the second handle axis is at a third angle relative to the column axis in the first position, wherein the second handle axis is at a fourth angle relative to the column axis in the second position, wherein the third angle is different from the fourth angle.

The handle axis and the second handle axis are parallel in the first position and the third position.

The actuating lever may be configured to rotate in a first rotational direction, and the second actuating lever may be configured to rotate in a second rotational direction opposite the first rotational direction.

The above presents a simplified summary in order to provide a basic understanding of some aspects of the systems and/or methods discussed herein. It is not an extensive overview of the systems and/or methods discussed herein. Nor is it intended to identify key/critical elements or to delineate the scope of such systems and/or methods.

### BRIEF DESCRIPTION OF THE DRAWINGS

FIG. 1 illustrates an exemplary surgical table.

FIG. 2 illustrates another view of the surgical table of FIG. 1.

FIG. 3 illustrates another view of the surgical table of FIG. 1 with one of the split leg assemblies detached.

FIG. 4 illustrates an exemplary latching assembly of a leg accessory.

FIG. 5 illustrates a cross-sectional view of the latching assembly of FIG. 9 along the plane indicated by line 5.

FIG. 6 illustrates an exploded view of the latching assembly of FIG. 4.

FIG. 7 illustrates a view of the latching assembly of FIG. 4 in a locking position.

FIG. 8 illustrates a view of the latching assembly of FIG. 4 in an unlocking position.

FIG. 9 illustrates another view of the latching assembly of FIG. 4 in the locking position.

FIG. 10 illustrates another view of the latching assembly of FIG. 4 in the unlocking position.

FIG. 11 illustrates a cross-sectional view of the latching assembly of FIG. 4 prior to being attached to a corresponding receptacle block of a surgical table, showing in cross-sectional view the latching assembly shown in FIG. 9 along the plane indicated at line 11 in FIG. 7.

FIG. 12 illustrates a cross-sectional view of the latching assembly of FIG. 4 attached to the corresponding receptacle block of the surgical table, showing in cross-sectional view the latching assembly shown in FIG. 9 along the plane indicated at line 11 in FIG. 7.

FIG. 13 illustrates a cross-sectional view of the latching assembly of FIG. 4 in shown in a state in which the latching assembly is detachable from the corresponding receptacle block of the surgical table, showing in cross-sectional view the latching assembly shown in FIG. 10 along the plane indicated at line 13 in FIG. 8.

FIG. 14 illustrates a view of an exemplary latching assembly in the locking position.

FIG. 15 illustrates a view of an exemplary latching assembly in the unlocked position.

FIG. 16 illustrates another view of an exemplary latching assembly in the locking position.

FIG. 17 illustrates another view of an exemplary latching assembly in the unlocked position.

### DETAILED DESCRIPTION

Aspects of the present application pertain to a split leg latching mechanism for attachment to a surgical table and are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details.

In reference to the disclosure herein, for purposes of convenience and clarity only, directional terms, such as, top, bottom, left, right, up, down, upper, lower, over, above, below, beneath, rear, and front, may be used. Such directional terms should not be construed to limit the scope of the features described herein in any manner. It is to be understood that embodiments presented herein are by way of example and not by way of limitation. The intent of the following detailed description, although discussing exemplary embodiments, is to be construed to cover all modifications, alternatives, and equivalents of the embodiments as may fall within the spirit and scope of the features described herein.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Additionally, as used herein, the term “exemplary” is intended to mean serving as an illustration or example of something and is not intended to indicate a preference.

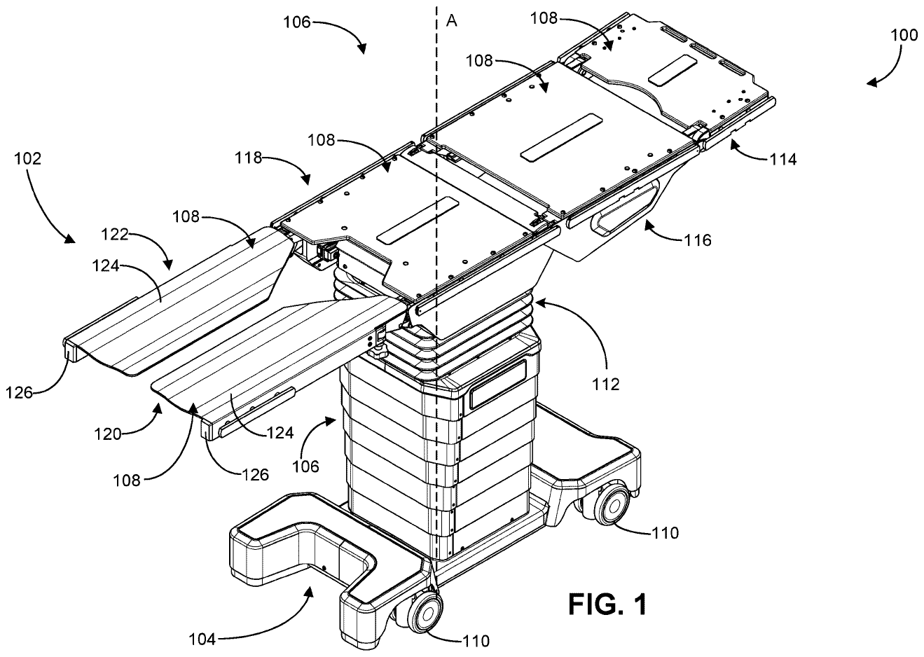

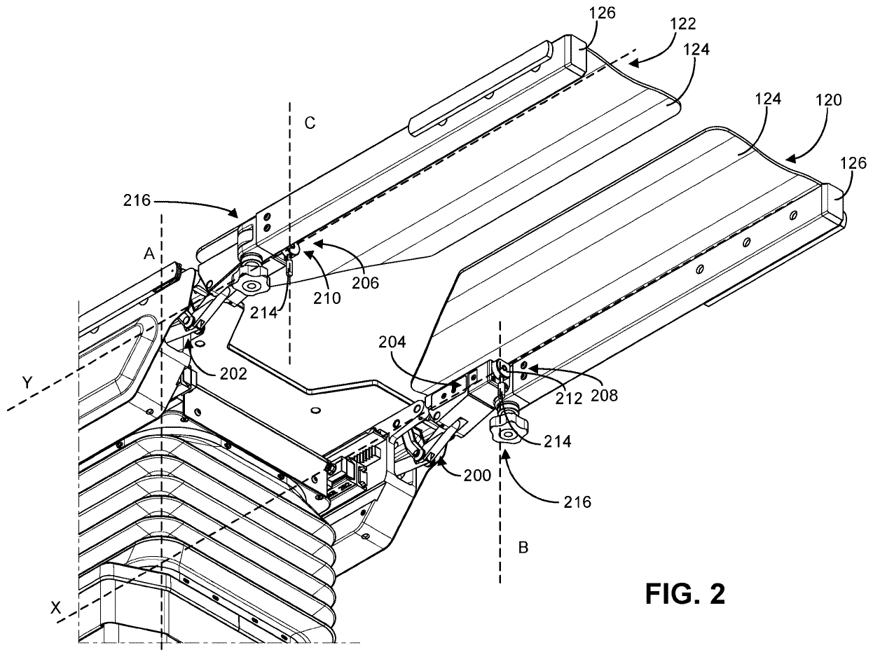

Turning to FIG. 1, a surgical table 100 is illustrated that includes one or more split leg assemblies 102 removably attachable thereto via a latching assembly (e.g., latching assembly 204, FIG. 2). The surgical table 100 further includes a base 104, a column 106 extending from the base 104, and one or more body support sections 108 arranged at an end of the column 106. The base 104 can take any suitable shape, size, and/or configuration for stably supporting the column 106, body support sections 108, and/or the split leg assemblies 102 to support a patient lying on the surgical table 100. In the illustrated embodiment, the base 104 further includes a plurality of wheels 110 that permit a user to maneuver the surgical table 100.

The column 106 is configured to extend along a column axis A and support the one or more body support sections 108. In the illustrated embodiment, the column axis A is a vertical axis that is perpendicular to horizontal or the horizon. Additionally, the column 106 can space the one or more body support section(s) 108 from the ground to make examination of the patient on the body support sections 108 more convenient. The column 106 may further include a table tilt and trend framework 112 that permits a user to articulate the body support sections 108 relative to one another as desired.

The surgical table 100 can include any suitable number of body support sections 108 and different configurations of body support sections 108 can be selected for different patients and/or users. The body support sections 108 can take any suitable shape and/or size for supporting the patient and different body support sections 108 may have different shapes and/or sizes for supporting different parts of the patient. In the illustrated embodiment, the surgical table 100 includes four body support sections 108 arranged adjacently. More specifically, the surgical table 100 includes a head support section 114 positioned to support a head of the patient, an upper torso support section 116 positioned to support an upper torso of the patient, a lower torso support section 118 positioned to support a lower torso of the patient, and a leg support section 120, 122 to support the legs of a patient.

In the illustrated embodiment, the surgical table 100 includes a pair of leg support sections that are removably attached to the column 106 and/or one or more of the other body support sections 108. For instance, the surgical table 100 may include a singular leg support section shaped to support both legs of a patient. In the illustrated example, the surgical table 100 includes two split leg assemblies 102, specifically a first split leg assembly 120 and a second split leg assembly 122, each shaped and positioned to individually support a leg of the patient. Each of the split leg assemblies 120, 122 can be fixed with respect to the other body support sections 108 when attached and/or may be movable with respect to the other body support sections 108 when the split leg assemblies 102 are attached to the column 106 and/or other body support sections 108. In the illustrated embodiment, the split leg assemblies 120, 122 are configured to split apart angularly such that their distal ends rotate outward from a central vertical plane that bisects the surgical table 100.

Each split leg assembly 120, 122 can take any suitable shape, size, and/or configuration for supporting a leg of the patient. In the illustrated embodiment, the first split leg assembly 120 and the second split leg assembly 122 are mirror arrangements of each other and each includes a support section 124 for supporting the leg of a patient, a support frame 126 to hold up the support section 124, and a latching assembly (e.g., latching assembly 204 (FIG. 2)) for removably attaching the split leg assemblies 120, 122 to the other component of the surgical table 100. The support sections 124 of the split leg assemblies 120, 122 may be made of a radiolucent structural material that is transparent to x-rays.

Each of the split leg assemblies 120, 122 can be removably attached to the same component of the surgical table 100 (e.g., the column 106) and/or each of the split leg assemblies 120, 122 can be removably attached to different components. Turning to FIG. 2, illustrated is an embodiment where the first split leg assembly 120 and the second split leg assembly 122 are removably attached to the same component, namely the lower torso support section 116. Accordingly, the lower torso support section 118 includes a separate receptacle block for each of the first split leg assembly 120 and the second split leg assembly 122, namely a first receptacle block 200 for the first split leg assembly 120 and a second receptacle block 202 for the second split leg assembly 122.

The receptacle blocks 200, 202 can be at any suitable location on the lower torso support section 118 and in the illustrated embodiment, the first receptacle block 200 and the second receptacle block 202 are positioned on a bottom surface of the lower torso support section 118 and flank the column 104. The receptacle blocks 200, 202 can have any suitable configuration such as a later described retaining surface 1102 against a corresponding split leg assembly 120, 122 can be removably held and latched. Similar to the first split leg assembly 120 and the second split leg assembly 122, the first receptacle block 200 and the second receptacle block 202 may be mirror arrangements of each other. Although the receptacle blocks 200, 202 are located in the lower torso support section 118 in this exemplary embodiment, in other exemplary embodiments the receptable blocks 200, 202 may be located on other body support sections 108, as desired.

As briefly noted above, the first split leg assembly 120 includes a first latching assembly 204 to removably attach the first split leg assembly 120 to the first receptacle block 200 and the second split leg assembly 122 includes a second latching assembly 206 to removably attach the second split leg assembly 122 to the second receptacle block 202. The first latching assembly 204 and the second latching assembly 206 can be at any suitable location on the respective split leg assemblies 120, 122 and may be similar and/or may vary.

In some exemplary embodiments, the latching assemblies 204, 206 are separate from, rather than for example integrated within, the respective support frame 126 to make the latching assemblies 204, 206 readily viewable by the user. Additionally, the latching assemblies 204, 206 include components such as a later described attachment pin 404 for removably attaching the respective split leg assembly 204, 206 to the retaining surface 1102 of the corresponding receptacle block 200, 202 of the surgical table 100. The first latching assembly 204 and the second latching assembly 206 can be located at any suitable portion of the respective split leg assembly and in the illustrated embodiment, the first latching assembly 204 and the second latching assembly 206 are located on a bottom surface of their respective split leg assemblies.

Each of the latching assemblies 204, 206 includes an actuating device (e.g., actuating lever 208) to selectively attach and/or detach the latching assemblies 204, 206 and their respective receptacle blocks 200, 202. More particularly, the first latching assembly 204 includes a first actuating lever 208 and the second latching assembly 206 includes a second actuating lever 210. The first actuating lever 208 and the second actuating lever 210 may be placed at any suitable location on the respective latching assembly and in the illustrated embodiment, the first actuating lever 208 and the second actuating lever 210 are mirror arrangements of each other.

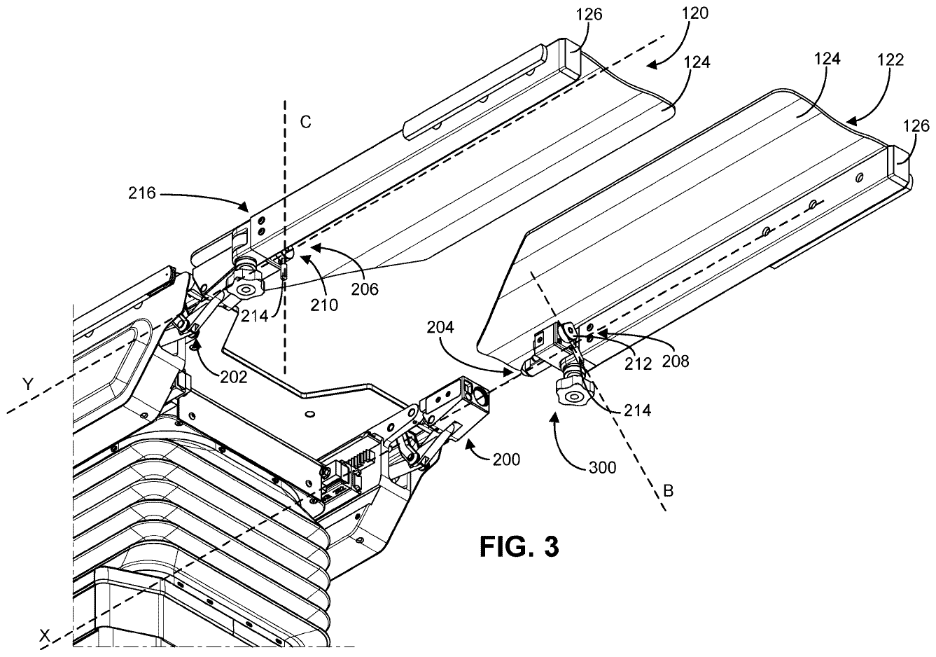

Moreover, the first actuating lever 208 and the second actuating lever 210 may be similar, as illustrated, and/or can vary. Each actuating lever 208, 210 includes a head 212 and a handle 214 that extends from the head 212. As shown in FIG. 3, the handle 214 of the first actuating lever 208 extends along handle axis B and the handle 214 of the second actuating lever 210 extends along handle axis C. The first actuating lever 208 and/or the second actuating lever 210 can be pivoted from a locking position 216 (FIG. 2) where the corresponding split leg assemblies 120, 122 are attached to the respective receptacle blocks 200, 202 to an unlocking position 300 (FIG. 3) where the corresponding split leg assemblies 120, 122 are detached from the respective receptacle blocks 200, 202. Any suitable movement can be used for pivoting the actuating levers 208 and 210 between the locking position 216 and the unlocking position 300 and in the FIG. 3 embodiment, the first actuating lever 208 rotates about an axis X and the second actuating lever 210 rotates about an axis Y that is parallel to the axis X.

In the locking position 216, the handle axis B is at a first angle with respect to the column axis A; in the illustrated embodiment, in the locking position 216, the handle axis B is at a first angle of zero degrees, that is parallel, with respect to the column axis A. In the unlocking position 300, the handle axis B is at a second angle with respect to the column axis A, which is different from the first angle; in the illustrated embodiment, in the unlocking position 300, the handle axis B is at a second angle of 45 degrees with respect to the column axis A. In the locking position 216, the handle axis C is at a third angle with respect to the column axis A; in the illustrated embodiment, in the locking position 216, the handle axis C is at a third angle of zero degrees, that is parallel, with respect to the column axis A. In the unlocking position 300, the handle axis C is at a fourth angle with respect to the column axis A, which is different from the third angle; in the illustrated embodiment, in the unlocking position 300, the handle axis C is at a second angle of 45 degrees with respect to the column axis A. The first angle of the handle axis B and the third angle of the handle axis C may be similar, as illustrated in FIG. 2, and/or can vary. The first angle of the handle axis B and the third angle of handle axis C can be any suitable arrangement, and, in the illustrated embodiment, the first angle and the third angle are parallel to the column axis A, as seen in FIG. 2.

Similarly, the second angle of the handle axis B and the fourth angle of the handle axis C may be similar and/or can vary. For instance, the handle 214 of the first actuating lever 208 can rotate in a first direction about axis X and the handle 214 of the second actuating lever 210 can rotate in a second direction about axis Y. The first direction and the second direction can be similar and/or can vary. In the illustrated embodiments, the first direction and the second directions are opposite, with the first direction being counterclockwise in the illustrated FIG. 2 and FIG. 3 while the second direction is clockwise. More specifically, the handle 214 of the first actuating lever 208 rotates away from the central vertical plane of the surgical table 100 toward an edge of the surgical table 100 from the locking position 216 to the unlocking position 300, as seen in FIGS. 2 and 3. Additionally, the handle 214 of the second actuating lever 210 rotates away from the central vertical plane of the surgical table 100 toward an edge of the surgical table from the locking position 216 to the unlocking position 300 opposite the movement of the handle 214 of the first actuating lever 208.

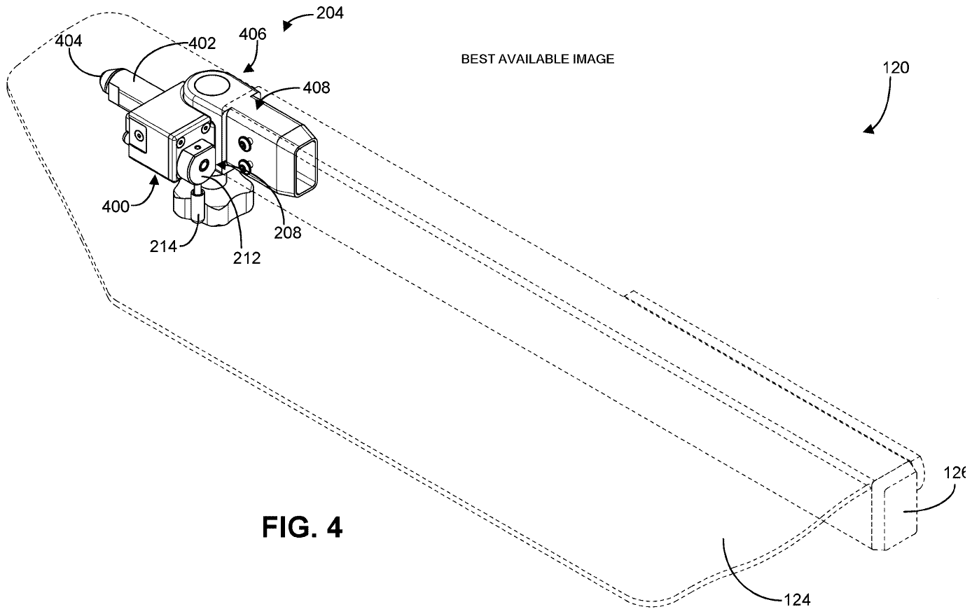

In the following embodiments in FIGS. 4-10, discussion is made with reference to the first split leg assembly 120, but the discussed features may be applied to the second split leg assembly 122. As noted above, because the first split leg assembly 120 and the second split leg assembly 122 are mirrors of each other, the hereafter described components and arrangements may be correspondingly mirrored for the second split leg assembly 122.

Turning now to FIG. 4, illustrated is the first split leg assembly 120 with the corresponding support section 124 and support frame 126 in shadow form to better view the first latching assembly 204. The first latching assembly 204 includes a housing 400 that retains one or more movable components to latch and unlatch the first split leg assembly 120 to the first receptacle block 200. In the illustrated embodiment, the first actuating lever 208 is disposed outside the housing 400 and attached thereto. In another embodiment, a portion of the first actuating lever 208 may be disposed and/or retained within the housing 400.

The first split leg assembly 120 further includes a mechanical latch shaft 402 with an attachment pin 404 at an end of the latch shaft 402 configured to selectively engage a corresponding retaining surface, for example the surface of a later described pin 1102, in the first receptacle block 200, as will be described in detail below. As can be seen in FIG. 4, a portion of the latch shaft 402 may be disposed in the housing 400, while a second portion may extend out of the housing 400. The second portion of the latch shaft 402 is configured such that during latching the second portion enters the first receptacle block 200 to attach thereto.

The housing 400 yet further includes an attachment point 406 configured for receiving a support frame attachment 408 to attach the support frame 126 to the housing 400. The support frame attachment 408 can be fixedly attached to the attachment point 406 or, as illustrated, the support frame attachment 408 can rotate with respect to the housing 400 via the attachment point 406 to permit the support section 124 and support frame 126 to rotate away from the central vertical plane of the surgical table 100.

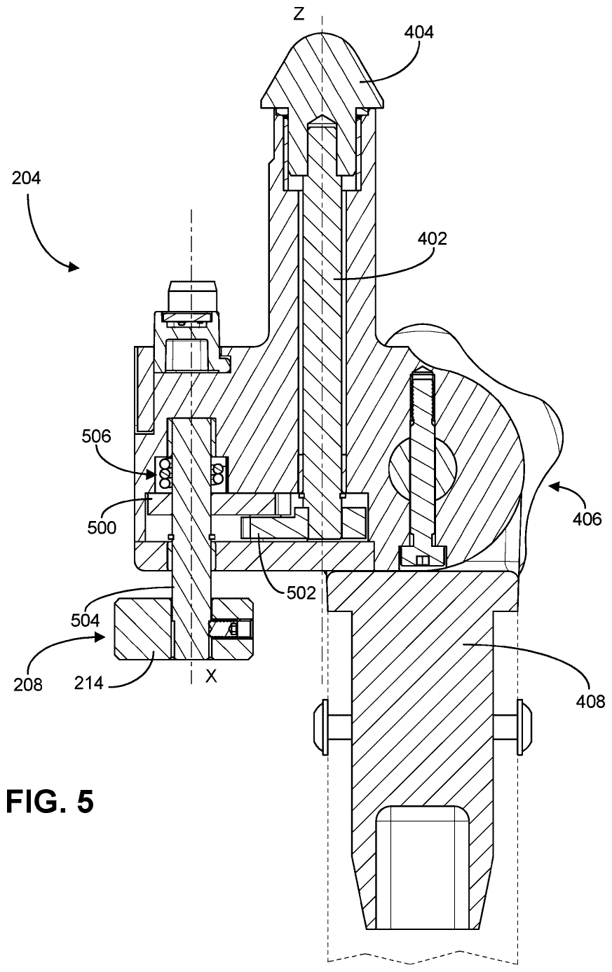

Turning now to FIG. 5, illustrated is a cross-sectional view of the first latching assembly 204 illustrated in FIG. 4. As can be seen in FIG. 5, the first latching assembly 204 includes one or more interlocking movable components that link the first actuating lever 208 and the latch shaft 402 such that rotation of the first actuating lever 208 about axis X causes a corresponding rotation of the latch shaft 402. In the illustrated embodiment, the first actuating lever 208 rotates about axis X while the latch shaft 402 rotates about axis Z that is different from axis X. Axis X and axis Z can be at any suitable angle with respect to each other and in the illustrated embodiment, axis X and axis Z are parallel.

To aid in making the first latching assembly 204 more compact and less susceptible to breakage and with reduced quantity and complexity of components, the axis Z of rotation of the latch shaft 402 and the axis X of rotation of the first actuating lever 208 are offset from one another and, as will be described in greater detail below, the latch shaft 402 requires for example about 45 degrees of rotation to release the first latch assembly 204 and thus the leg accessory 120 from the surgical table.

The first latching assembly 204 can include any suitable number of interlocking movable components. In an illustrated embodiment, the first latching assembly 204 includes two interlocking movable components, namely a first movable component 500 and a second movable component 502 (hereafter movable components 500, 502). The first movable component 500 and the second movable component 502 can move in any suitable manner for linking the first actuating lever 208 and the latch shaft 402. In the illustrated embodiment, the movable components 500, 502 are rotationally connected such that rotation of the first movable component 500 causes rotation of the second movable component 502 and vice-versa. The first movable component 500 can be attached to the first actuating lever 208 such that rotation of the first actuating lever 208 causes similar rotation of the first movable component 500 and vice versa. As can be seen in FIG. 5, the first movable component 500 is connected to the first actuating lever 208 by a drive shaft 504. The second movable component 502 can be attached to the latch shaft 402 such that rotation of the second movable component 502 caused by the rotation of the first movable component 500 drives rotation of the latch shaft 402. As can be seen in FIG. 5, the drive shaft 504 and the latch shaft 402 can be arranged with respect to the housing 400 to extend from opposing sides of the housing 400. More specifically, the drive shaft 504 extends through a first side of the housing 400 and the latch shaft 402 extends through a second side of the housing 400 opposite the first side.

The first movable component 500 may include a first body portion 510 that rotates in a first plane and the second movable component 502 may include a second body portion 512 that rotates in a second plane. The first movable component 500 and the second movable component 502 can take any suitable shape, size, and/or configuration and the arrangement of the first and second body portions 510, 512 of the respective first and second movable components 500, 502 may depend on their respective shape, size, and/or configuration. For instance, where the first movable component 500 and the second movable component 502 comprise gears, the first and second planes of the first and second body portions 510, 512 of the respective first and second movable components may be the same. In the illustrated embodiment, the first plane and the second plane are different, for example, in that the first body portion 510 of the first movable component 500 and the second body portion 512 of the second movable component 502 partially overlap and are next to one another in the axial direction, where the axial direction in the illustrated embodiment is parallel to the rotation axis X and the rotation axis Z. Advantageously, by overlapping the first body portion 510 of the first movable component 500 and the second body portion 512 of the second movable component 502 axially as shown, the illustrated first latching assembly 204 can increase the size and thus the strength of the first and second movable components 500, 502 while maintaining the compact size of the first latching assembly 204, at least as compared to linkage or gear type latching assemblies.

The first latching assembly 204 can further include a biasing member 506 configured to bias the first movable component 500 toward the latching position and/or the unlatching position. In the illustrated embodiment, the biasing member 506 biases the first movable component 500 toward the latching position. As such, unlatching the first split leg assembly 120 from the first receptacle block 200 involves rotating the first latching assembly 204 against the bias.

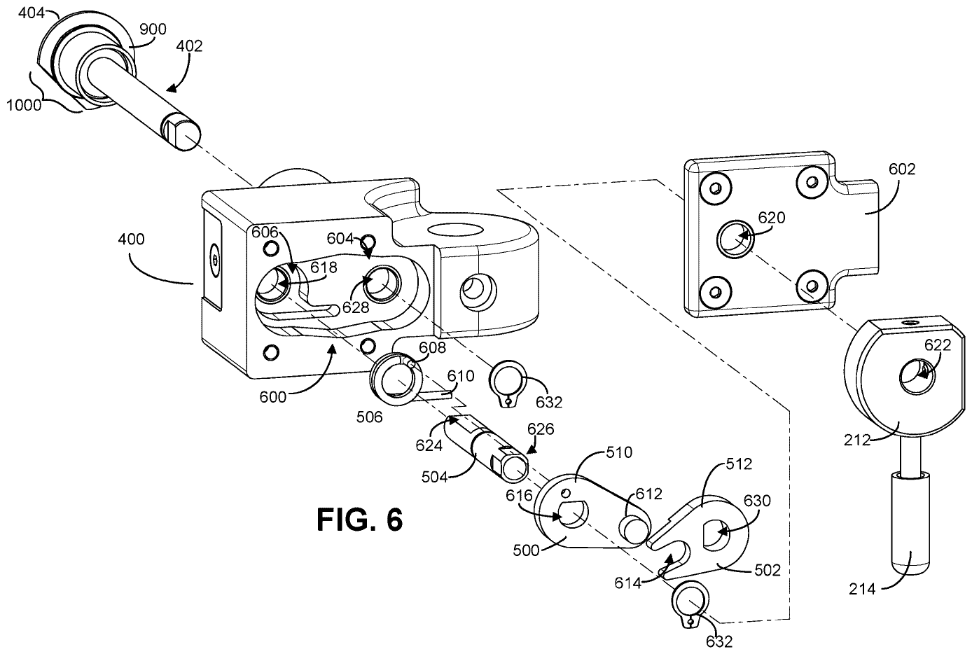

Turning now to FIG. 6, illustrated is an exploded view of the first latching assembly 204 of FIG. 4. The housing 400 can take any suitable shape, size, and/or configuration for retaining any of the above described components while permitting rotation of the first movable component 500 and the second movable component 502 between the latching position and the unlatching position. In the illustrated embodiment, the housing 400 includes a recess 600 that receives the first movable component 500, the second movable component 502, and the biasing member 506 and a cover 602 attached to the remaining portion of the housing 400 to cover the recess 600.

The recess 600 can be configured to define rotation boundaries that only permit rotation of the first movable component 500 and/or second movable component 502 between the latching position and the unlatching position, for example, about 45 degrees.

The recess 600 can further have a uniform depth and/or the depth can vary. In the illustrated embodiment, the recess 600 has a first section 604 that permits both the first movable component 500 and the second movable component 502 to be fully inserted into the first section 604. The recess 600 further includes a second section 606 that extends further into the housing 400 from the first section 604 to receive and retain the biasing member 506 in the recess 600.

Any suitable biasing member 506 can be used and in the illustrated embodiment, the biasing member 506 is a torsion spring. The torsion spring includes a first leg 608 that engages an opening of the first movable component 500 and a second leg 610 that engages a wall of the second section 606. The torsion spring is positioned to bias the first movable component 500 toward the latching position.

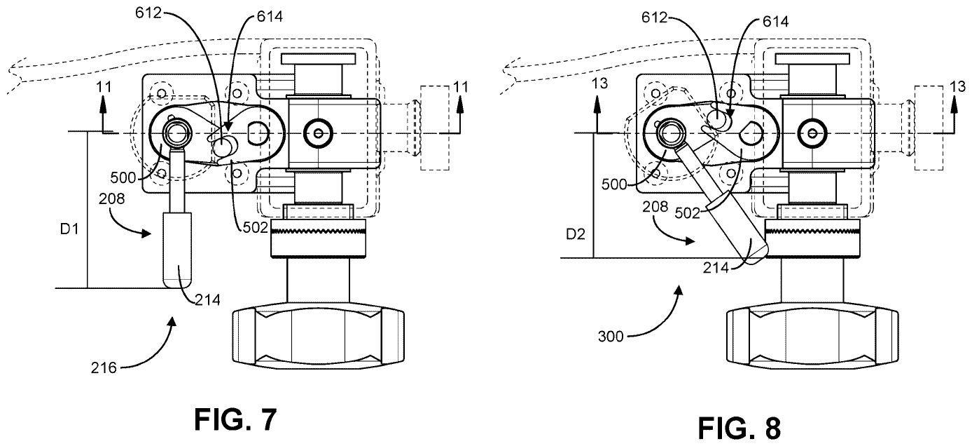

As noted above, the first movable component 500 and the second movable component 502 can take any suitable shape, size, and/or configuration for causing rotation of the latch shaft 402 based on movement of the first actuating lever 208. In the illustrated embodiment, the first latching assembly 204 includes a pin 612 that extends axially from a surface of the first body portion 510 of the first movable component 500. The pin 612 extends axially such as to be movable in the second plane of the second body portion 512 of the second movable component 502. Referring to FIG. 6, the pin 612 extends axially along an axis that is parallel to and radially spaced from the rotation axis X of the first movable component 500. The second body portion 512 of the second movable component 502 has a fork shape and includes a pair of arms, in the illustrated embodiment an upper arm and a lower arm, that define a notch 614 shaped to receive the pin 612. Referring to FIGS. 5-8, the inner wall of the upper arm and the inner wall of the lower arm are parallel to one another and parallel to a line extending radially and perpendicularly from the rotation axis Z of the second movable component 502. Referring to FIGS. 6-8, the illustrated pin 612 of the first movable component 500 is circular in shape in axial cross section and has a diameter slightly less than the width between the inner wall of the lower arm and inner wall of the upper arm of the fork shape second movable component 502. As shown in FIGS. 7 and 8, as the circular shape pin 612 moves through the notch 614, the pin 612 has its entire circular shape between the inner wall of the lower arm and inner wall of the upper arm of the fork shape second body portion 512 of the second movable component 502.

Referring to FIG. 6, the notch 614 extends axially along an axis that is parallel to and radially spaced from the rotation axis Z of the second movable component 502. The upper and lower arms of the fork shape second body portion 512 of the second movable component 502 are configured to engage the pin 612 such that rotation of the first movable component 500 causes the pin 612 to engage the upper arm in one rotation direction and the lower arm in an opposite rotation direction to respectively rotate the second movable component 502 in opposite directions. Thus, as the first movable component 500 rotates, the pin 612 travels radially in the notch 614 alongside the inner walls of the upper and lower arms of the fork shape second body portion 512 to drive a corresponding rotation of the second movable component 502. In the illustrated configuration, the pin 612 and notch 614 arrangement aid in rotating the first movable component 500 and the second movable component 502 in opposing directions. For instance, referring to FIGS. 5-8, rotation of the first movable component 500 counterclockwise about the axis X causes clockwise rotation of the second movable component 502 about the axis Z, and vice-versa, via the pin 612 sliding engagement with the upper and lower arms of the notch 614.

In some embodiments, the first movable component 500 may be in the form of a crank member including the pin 612 as a crank pin of the crank member 500, and the second movable component 502 may take the form of a driven member having the notch 614 therein as a radial slot within which the crank pin slides as the crank member 500 and the driven member 502 rotate. As will be appreciated, the first latch assembly 204 including the crank member 500 and the crank pin 612 thereof, and the driven member 502 and the radial slot 614 thereof, may take the form of a simplified Geneva type drive mechanism, in the sense that the first latching assembly 204 provides offset rotation of the two rotation axes X, Z of the respective drive shaft 504 and latch shaft 402 in opposite directions, and the second body portion 512 of the second movable component 510 is shaped like a fork to receive the pin 612 of the first body portion 510 of the first movable component 500 such that when the pin 612 rotates in a first direction, the pin 612 slides in the fork and causes the fork shape second body portion 512 of the second movable component 502 to rotate in a second direction that is opposite the first direction; it being understood that typically Geneva drives are used for intermittent rotary motion, but the first latching assembly 204 provides a limited motion through about 45 degrees of rotation as shown going from FIG. 7 to FIG. 8.

With continued reference to FIG. 6, the drive shaft 504 can have any suitable shape to connect the first movable component 500 and the first actuating lever 208 relative to the housing 400. In the FIG. 6 embodiment, to connect the different components via the drive shaft 504, the first movable component 500 includes an opening 616 to allow the drive shaft 504 to extend therethrough and lock rotationally relative to the movable component 500. Similarly, the housing 400 includes an opening 618 that receives and rotationally supports an end of the drive shaft 504, and the cover 602 includes an opening 620 that receives and rotationally supports an opposite end of the drive shaft 504. The drive shaft 504 extends through and beyond the opening 620 in the cover 602. The head 212 of the first actuating lever 208 includes an opening 622 to receive the portion of the drive shaft 504 extending beyond the opening 620 in the cover 602. The head 212 may be secured to the drive shaft 504 by a set screw or the like engaging a flat on the drive shaft 504. As can further be seen in FIG. 6, the torsion spring 506 is shaped to extend around the drive shaft 504 in the assembled position.

The drive shaft 504 has a nonuniform cross-section along a length of the drive shaft 504, as illustrated. Thus, the drive shaft 504 includes a first section 624 with a first cross-section that interacts with the opening 616 in the first movable component 500 to rotationally lock the first movable component 500 and the drive shaft 504. The illustrated drive shaft 504 further includes a second section 626 with a second cross-section that interacts with the opening 622 of the first actuating lever 208 to rotationally lock the first actuating lever 208 to the drive shaft 504, and by extension the first movable component 500.

The housing 400 further includes a second opening 628 that extends through the housing 400 from the recess 600 to connect the attachment pin 404 to the second movable component 502 via the latch shaft 402. Similar to the drive shaft 504 and the first movable component 500, the second movable component 502 includes an opening 630 and a portion of the latch shaft 402 is shaped to interact with the opening 630 to rotationally lock the latch shaft 404 relative to the second movable component 502.

The first latching assembly 204 further includes retaining clips 632 to axially retain the drive shaft 504 in the opening 620 in the cover 602 and axially retain the latch shaft 402 in the second opening 628 in the housing 400.

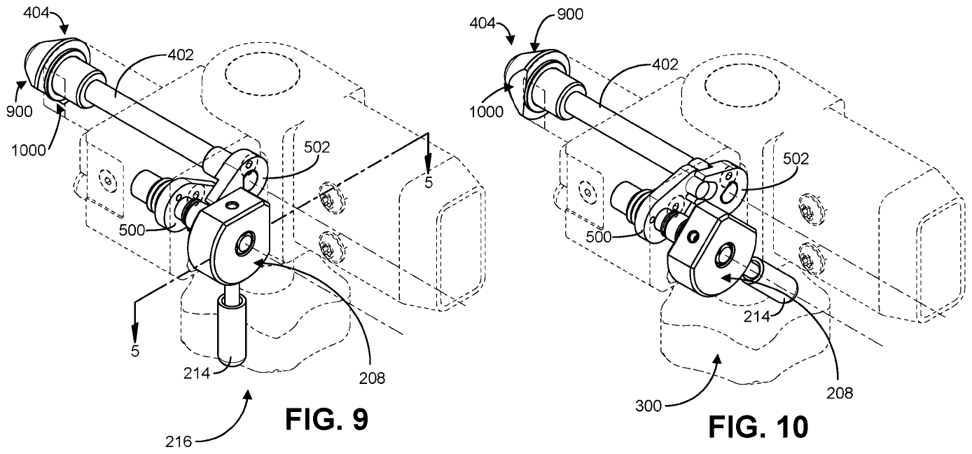

FIGS. 7-10 illustrate the first latching assembly 204 in the locking position 216 (FIGS. 7 and 9) and the unlocking position 300 (FIGS. 8 and 10) with portions of the first latching assembly 204 shadowed out to provide a clearer view of the first and second movable components 500, 502. As can be seen in FIG. 7, in the locking position 216, the pin 612 of the first movable component 500 is biased downward by the biasing member 506, that is clockwise about the axis X, which, via sliding engagement in the notch 614 first radially toward the axis Z and subsequently radially away from the axis Z, the pin 612 drives the lower arm of the fork shape second body portion 512 of the second movable component 502 downward, that is counterclockwise about the axis Z, such that the handle 214 of the first actuating lever 208 is oriented downward. In the locking position 216, an end of the handle 214 is a first distance D1 from a rotational center of the first actuating lever 208.

When the first actuating lever 208 is pivoted, for example 45 degrees counterclockwise to the unlocking position 300 as shown in FIG. 8, the pin 612 of the first movable component 500 is driven upward against the bias of the biasing member 506, that is counterclockwise about the axis X. The upward movement of the pin 612 correspondingly, via sliding engagement in the notch 614, drives the upper arm of the fork shape second body portion 512 of the second movable component 502 upward, that is clockwise about the axis Z, as the pin 612 travels radially in the notch 614 first radially toward the axis Z and subsequently radially away from the axis Z, which, in turn rotates the second movable member 502 clockwise. In the unlocking position 300, the end of the handle 214 is a second distance D2 from the rotational center of the first actuating lever 208 which is less than the first distance D1. As will be appreciated, the handle 214 when at the first distance D1 is more easily viewable to the user than when the handle 214 is at the second distance D2. Further, the handle 214 does not project inward to a position under the radiolucent support section 124, see FIG. 2.

As can be seen in FIGS. 9 and 10, the attachment pin 404 is attached to the latch shaft 402 such that rotation of the second movable component 502 causes the attachment pin 404 to rotate. The illustrated attachment pin 404 includes a first part 900 and a second part 1000. The first part 900 is shaped to engage the corresponding retaining surface, for example the surface of a later described pin 1102, in the first receptacle block 200 to latch the first latching assembly 204 and the first receptacle block 200 together. The second part 1000 is shaped to allow disengagement of the first latching assembly 204 from the corresponding retaining surface in the first receptacle block 200. In the illustrated embodiment, the first part 900 of the attachment pin 404 is in the form of a radially protruding member 900 protruding radially outward from the rotation axis Z of the latch shaft 402 of the second movable component 502. The geometry of the radially protruding member 900 is in the form of a catching arc portion 900. In the illustrated embodiment, the second part 1000 of the attachment pin 404 is in the form of a radially protruding void 1000 protruding radially outward from the rotation axis Z of the latch shaft 402 of the second movable component 502, and which is angularly adjacent to the radially protruding member 900 about the rotation axis Z. The geometry of the radially protruding void 1000 is in the form of a non-catching open chord portion.

In the locking position 216 (FIG. 9), the first part 900, or radially protruding member 900, of the attachment pin 404 is positioned to axially overlap with and thus axially engage the corresponding retaining surface in the first receptacle block 200, for example the surface of the later-described pin 1102. Conversely, in the unlocking position 300 (FIG. 10), the first part 900, or radially protruding member 900, is rotated away from the corresponding retaining surface, and the second part 1000, or radially protruding void 1000, is axially toward the corresponding retaining surface, wherein the second part 1000, or radially protruding void 1000, is shaped so as not to axially overlap with or axially engage the corresponding retaining surface.

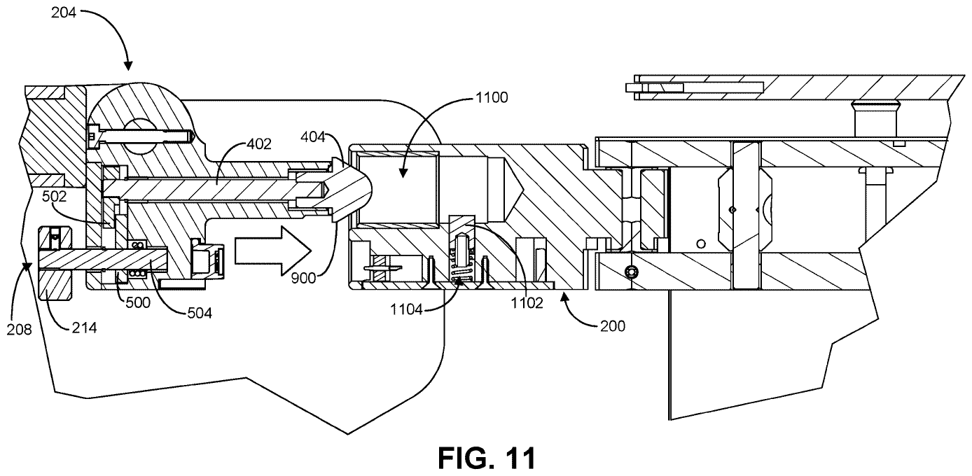

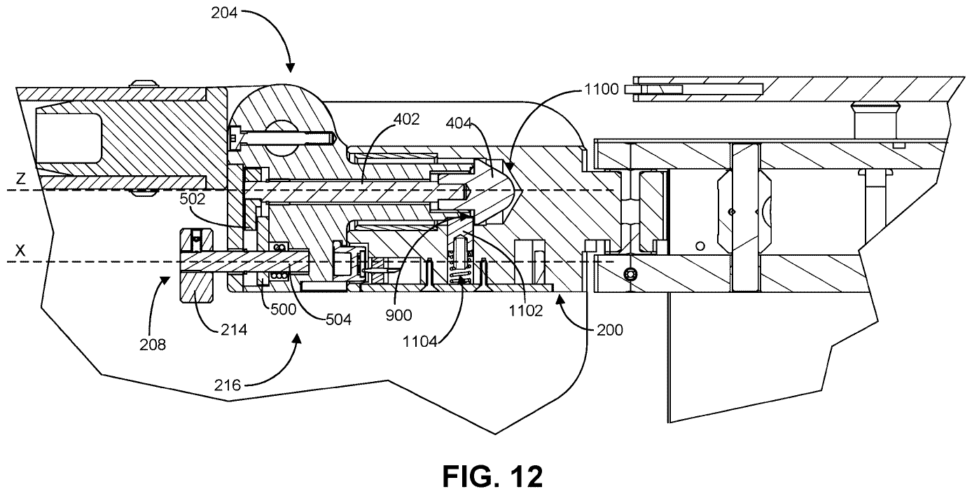

Turning now to FIGS. 11-13, illustrated is a cross-sectional view of the process of attaching and then detaching the first latching assembly 204 to the first receptacle block 200. The first receptacle block 200 includes a receptacle 1100 configured to receive a portion of the first latching assembly 204 to latch the first receptacle block 200 and the first latching assembly 204 together. The first receptacle block 200 further includes a retaining surface in the form of a pin 1102 that extends into the receptacle 1100 and is positioned to axially overlap with and thus axially engage the first part 900, or radially protruding member 900, of the attachment pin 404 to latch the first latching assembly 204 to the first receptacle block 200. In the illustrated embodiment, the corresponding retaining surface, that is the pin 1102, is configured to move, for example radially into and out of the receptacle 1100. Thus, the pin 1102 is configured to move radially outward to allow insertion of the attachment pin 404 axially through the receptacle 1100 and, once the attachment pin 404 has reached the locking position 216 shown in FIG. 12, the pin 1102 is configured to return to the engagement position to overlap with and thus engage the first part 900, or radially protruding member 900, of the attachment pin 404. In the illustrated embodiment, the pin 1102 is movable radially and includes a spring 1104 that biases the pin 1102 toward the engagement position; that is, the spring 1104 biases the pin 1102 radially inward into the receptacle 1100. In some embodiments, the pin 1102 can be fixed within the receptacle 1100; that is, the pin 1102 may be fixed relative to the receptacle 1100, the pin 1102 projecting radially inward into the receptacle 1100. In such case, to insert the attachment pin 404 into the receptacle 1100 to the position shown in FIG. 12, the attachment pin 404 has to be rotated so that the second part 1000, or radially protruding void 1000, aligns axially with the pin 1102, enabling the attachment pin 404 to pass by the pin 1102 unobstructed.

Starting in FIG. 11, the attachment pin 404 is aligned with the entrance of the receptacle 1100 and the first latching assembly 204 is inserted into the receptacle 1100. As the attachment pin 404 travels in the receptacle 1100, a sloped surface of the attachment pin 404 presses the pin 1102 downward against the bias of the spring 1104 such that the pin 1102 withdraws from the receptacle 1100 as the sloped surface presses against the pin 1102, thus allowing insertion of the attachment pin 404 into the receptacle 1100, from left to right going from FIG. 11 to FIG. 12. When the attachment pin 404 reaches the locking position 216 shown in FIG. 12, the spring 1104 urges the pin 1102 back to the engagement position so that the pin 1102 overlaps with and thus engages the first part 900, or radially protruding member 900, of the attachment pin 404. The pin 1102, by overlapping with and engaging the first part 900 of the attachment pin 404, prevents withdrawal of the attachment pin 404 from the receptacle 1100, thus latching the first latching assembly 204 and corresponding split leg assembly 120 to the first receptacle block 200.

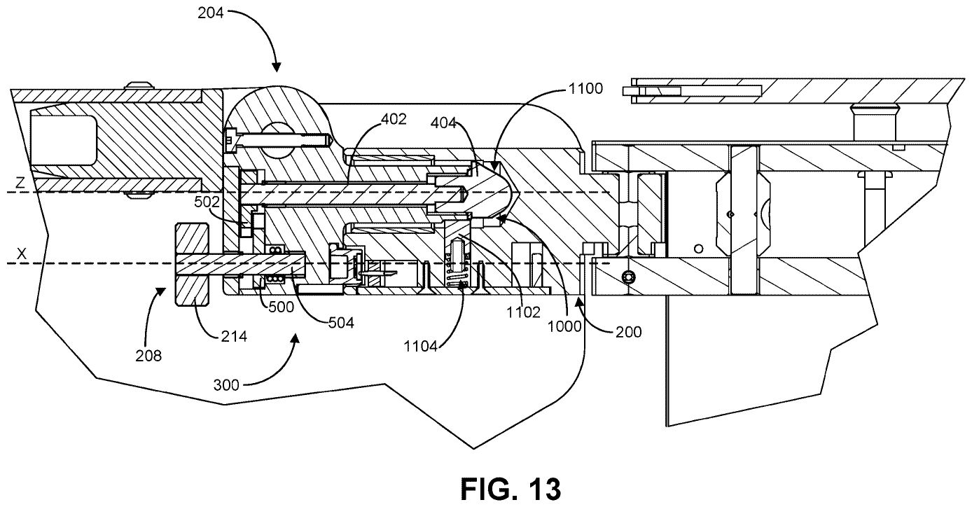

In FIG. 13, the first actuating lever 208 is rotated and the second part 1000, or radially protruding void 1000, is rotated toward the pin 1102, and the angularly adjacent first part 900, or radially protruding member 900, is rotated away from the pin 1102; as such, the attachment pin 404 does not axially overlap with or engage the pin 1102. Accordingly, in FIG. 13, as the attachment pin 404 no longer overlaps with or engages the pin 1102, the attachment pin 404 can be removed from the receptacle 1100 and, correspondingly, the first latching assembly 204 and corresponding split leg assembly 120 can be removed from the first receptacle block 200.

As will be appreciated, the first latching assembly 204 including the first movable component 500 and the pin 612 thereof, and the second movable component 502 and the notch 614 thereof, provides several advantages over prior latching assemblies. For example, the first latching assembly 204 consumes a smaller volumetric footprint than, for example, a latching assembly using linkages and/or gears. The volumetric footprint of the first latching assembly 204 has very little projection under the radiolucent support section 124 of the leg assembly 120, so as not to obstruct an x ray path passing through the support section 124, see FIG. 2. The first latching assembly 204 does not employ small size intricate components that are prone to break and/or require a large quantity of such components. The first latching assembly 204 is simpler in construction than prior latching assemblies, and uses only a few components, thereby making manufacture of the first latching assembly 204 less complex and lower in cost. In this regard, the inventor found that linkages for a latching assembly of approximately the same volumetric footprint as the first latching assembly 204 necessitate the use of small diameter pins and holes in linkages, presenting concerns with part strength. Also, for example, the inventor found that linkages for a latching assembly of approximately the same volumetric footprint as the first latching assembly 204 require an increased part count, for example, linkage, pin, pin mount, pin retainer, among others. Also, for example, the inventor found that for a gear-equipped latching assembly of approximately the same volumetric footprint as the first latching assembly 204, complex and precise manufacturing methods are required to ensure reliable motion transfer. The first latching assembly 204 according to one or more embodiments of the invention described herein overcomes one or more of the foregoing problems or shortcomings of such prior latching assemblies.

Similar to what is shown and described in FIG. 5, the first latching assembly 1204 may include one or more interlocking movable components that link the first actuating lever 208 and the latch shaft 402 such that rotation of the first actuating lever 208 about axis X causes a corresponding rotation of the latch shaft 402. Similarly, portions of the first latching assembly 1204 may include similarly functionality and components to that of the first latching assembly 204 described herein.

In exemplary embodiments, the first latching assembly 1204 includes a housing 1400 that retains one or more movable components to latch and unlatch the first split leg assembly 120 (not shown) to the first receptacle block 200, similar to what is shown in and described in FIG. 5. The handle 1208 is disposed outside the housing 1400 and attached thereto. In another embodiment, a portion of the handle 1208 may be disposed and/or retained within at least a portion the housing 1400.

The first latching assembly 1204 can include any suitable number of interlocking movable components. In an illustrated embodiment, the first latching assembly 1204 includes two interlocking movable components, namely a first movable component 1210 and a second movable component 1502 (hereafter movable components 1210, 1502). The first movable component 1210 and the second movable component 1502 can move in any suitable manner for linking the first actuating lever 208 and the latch shaft 402. In the illustrated embodiment, the movable components 1210, 1502 are connected in such a way where the linear movement of movable component 1210 causes rotational of the second movable component 1502 and vice-versa. The first movable component 1210 can be attached to a handle 1208 via a shaft 1214 that connects the first movable component 1210 to the handle 1218. Linear movement of the handle 1218 rotation of the first movable component 500 and vice versa. In exemplary embodiments, the shaft 1214 is connected to the handle 1218 by threaded connection, welding, or any other suitable way of connection. In some exemplary embodiments, the shaft 1214 and handle 1218 may be integrally formed. Similarly, the shaft 1214 is connected to moveable component 1210 by threaded connection, welding, or any other suitable way of connection. In some exemplary embodiments, moveable component 1210 and shaft 1214 may be integrally formed. In exemplary embodiments, movable component 1210 is connected to engagement member 1212 in any suitable manner, such as by welding, threaded connection, press fit, etc. In some exemplary embodiments movable component 1210 and engagement member 1212 may be integrally formed.

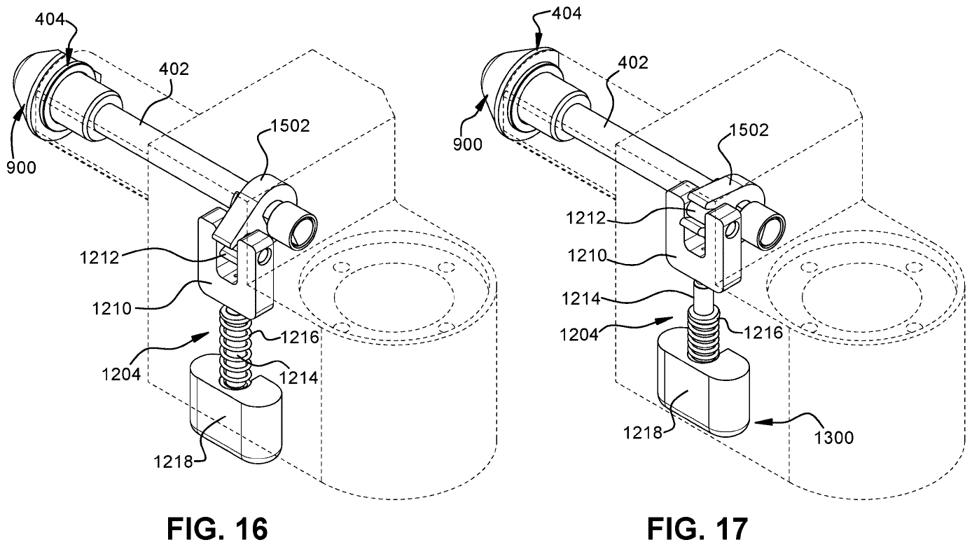

As can be seen in FIGS. 16-18, the latch shaft 402 can be arranged with respect to the housing 400 to extend within housing 1400, and movable component 1210, along with at least a portion of shaft 1214 and the handle 1218 may extend within housing 1400. More specifically, movable component 1210, along with at least a portion of shaft 1214 and the handle 1218 extends through a first side of the housing 1400 and the latch shaft 402 extends through a second side of the housing 1400 opposite the first side. In some embodiments, the latch shaft 402 is secured within housing 1400 by use of a washer 1602 and clip 1604, and rotation of the latch shaft is aided by the use of a bushing 1600. In exemplary embodiments, the housing 1400 includes a recess 1404 where portions of the latching assembly 1204 are housed during use. Additionally, the housing 1400 includes a recess 1402 where additional portions of the latching assembly 1204 may be situated during use. In some exemplary embodiments recess 1402 and recess 1404 may be integrally formed. In exemplary embodiments, housing 1400 may include a cover 1406 that is attached to housing via one or more threaded fasteners 1412, 1414. The cover 1406 is designed to allow for easier manufacturing and assembly of the latching assembly. Any type of suitable cover design and attachment may be used to allow easier assembly and maintenance of the latching assembly.

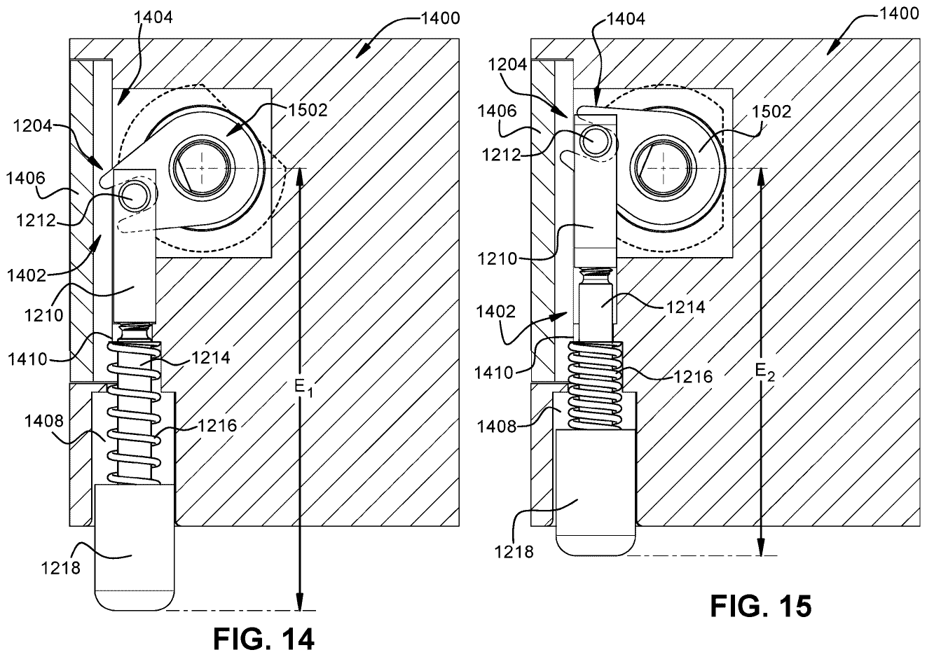

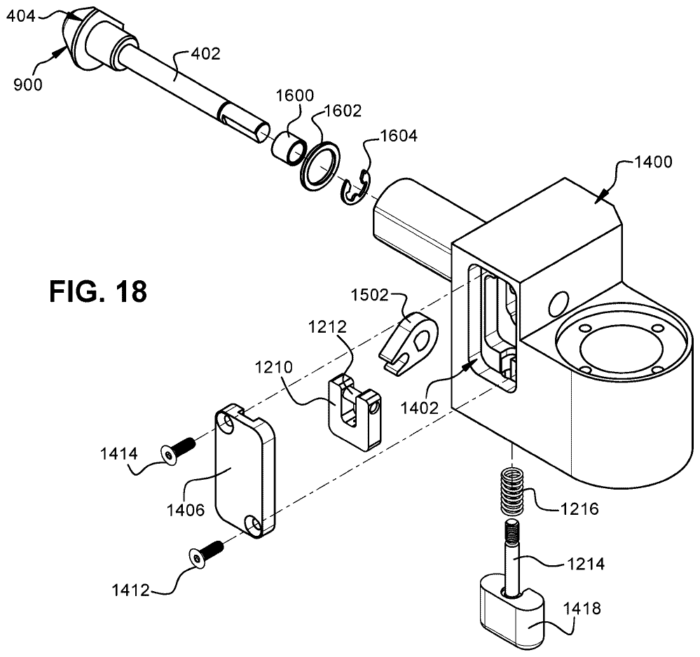

FIGS. 14-18 illustrate another exemplary embodiment of a first latching assembly 1204 in the locking position 1216 (FIGS. 14 and 16) and the unlocking position 1300 (FIGS. 15 and 17) with portions of the first latching assembly 1204 shadowed out to provide a clearer view of a first and second movable components 1210, 1502. As can be seen in FIG. 14, in the locking position 1216, the engagement member 1212 of a first movable component 1210 is biased downward by the biasing member 1216, that is linear along axis C, and via sliding engagement within recesses 1402 and 1404 in the housing 1400. The biasing member 1216 drives movable member 1210 downward by engaging a surface 1410 of the housing within a recess 1408 of the housing. The downward movement of movable member 1210 provides corresponding downward motion of the second movable component 1502, that is counterclockwise about the axis Z as described in FIG. 5, such that the handle 1218 is biased downward. In the locking position 1216, an end of the handle 1218 is a first distance E1 from a rotational center of the second movable component 1502.

When the handle 1218 is moved linearly along axis C, for example a few inches to the unlocking position 1300 as shown in FIG. 15, the engagement member 1212 of the first moveable component is driven upward against the bias of the biasing member 1216, that is opposed in the axis C direction. The upward movement of the engagement member 1212 correspondingly, via sliding engagement in the housing 1400 drives the upper arm of the fork shape second body portion 1512 of the second movable component 1502 upward, that is clockwise about the axis Z, as the pin 1612 travels radially in a notch first radially toward the axis Z and subsequently radially away from the axis Z, which in turn rotates the second movable member 1502 clockwise. In the unlocking position 1300, the end of the handle 1218 is a second distance E2 from the rotational center of the second movable component 1502, which is a distance less than the first distance E1. As will be appreciated, the handle 1218 when at the first distance E1 is more easily viewable to the user than when the handle 1218 is at the second distance E2. Further, the handle 1218 does not project inward to a position under the radiolucent support section 124, as seen in FIG. 2.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A latching mechanism for selectively latching and unlatching a leg accessory of a surgical table relative to a retaining surface in the surgical table, comprising:
interlocking first and second movable components, wherein the first movable component and the second movable component are arranged such that movement of the first movable component in a first direction causes rotation of the second movable component in a second rotational direction;
an actuating device connected to the first movable component such that moving of the actuating device causes movement of the first movable component;
an attachment pin for removably attaching the leg accessory to the surgical table, wherein the attachment pin is connected to the second movable component to rotate as the second movable component rotates, wherein the attachment pin includes an engagement surface moveable between a first position and a second position in response to rotation of the attachment pin, for respectively engaging and disengaging the retaining surface in the surgical table; and
a biasing member configured to bias the attachment pin including the engagement surface thereof toward the first position, wherein the actuating device is movable against the bias of the biasing member to move the attachment pin and engagement surface thereof from the first position to the second position.

2. The latching mechanism of claim 1, wherein the second movable component is arranged such that linear movement of the first movable component in a first direction causes rotation of the second movable component in a second rotational direction, and wherein the actuating device is connected to the first movable component such that linear movement of the actuating device causes corresponding linear movement of the first movable component.

3. The latching mechanism of claim 1, wherein the second movable component is arranged such that rotational movement of the first movable component in a first direction causes rotation of the second movable component in a second rotational direction opposite the first rotational direction, and wherein the actuating device is connected to the first movable component such that pivoting of the actuating device causes rotation of the first movable component.

4. The latching mechanism of claim 3, wherein the first movable component has a first body portion that rotates in a first plane, and the second movable component has a second body portion that rotates in a second plane that is different from the first plane.

5. The latching mechanism of claim 3, wherein first movable component has a first body portion that rotates about a first axis, and the second movable component has a second body portion that rotates about a second axis that is parallel to the first axis, wherein the first body portion and the second body portion partially overlap so as to be stacked in an axial direction.

6. The latching mechanism of any of claim 4, wherein the first movable component includes a pin extending axially from a surface of the first body portion of the first movable component, wherein the pin of the first movable component moves in the second plane of the second body portion of the second movable component.

7. The latching mechanism of any of claim 1, wherein the first movable component includes a pin, wherein the second movable component includes a notch therein, wherein the pin and the notch are configured such that movement of the first and second movable components causes the pin to move radially in the notch relative to a rotation axis of the second movable component.

8. The latching mechanism of any of claim 3, wherein the first movable component is a crank member including a crank pin, and the second movable component is a driven member having a notch therein as a radial slot within which the crank pin slides as the crank member and driven member rotate.

9. The latching mechanism of claim 3, wherein the first movable component includes a first body portion and a pin extending axially from a surface of the first body portion, wherein the second movable component has a fork shape and includes a pair of arms configured to engage the pin such that movement of the first movable component causes the pin to engage the pair of arms to rotate the fork shape second movable component.

10. The latching mechanism of claim 3, wherein the biasing member is a torsion spring that is attached to the first movable component and configured to bias the attachment pin toward the first position via the interlock between the first and second movable components.

11. The latching mechanism of claim 2, wherein the biasing member is a compression spring that is attached to the first movable component and configured to bias the attachment pin toward the first position via the interlock between the first and second movable components.

12. The latching mechanism of claim 1, further comprising a housing including:
a housing body with a recess shaped to support the first movable component and the second movable component; and
a cover to cover the housing body and to retain the first movable component and the second movable component in the housing body.

13. The latching mechanism of claim 12, wherein the actuating lever is connected to the first movable component by a drive shaft, wherein the drive shaft extends through an aperture in the cover such that the actuating lever can be arranged on an opposing side of the cover as the first movable component,
wherein the attachment pin is connected to the second movable component by a mechanical latch shaft that extends through an opening in the housing.

14. The latching mechanism of any of claim 1, in combination with a leg accessory and a surgical table including a retaining surface, wherein the latching mechanism is connected to the leg accessory, and wherein in the first position the engagement surface of the attachment pin engages the retaining surface in the surgical table to attach the leg accessory to the surgical table, wherein in the second position the engagement surface is positioned away from the retaining surface in the surgical table to enable removal of the leg accessory from the surgical table.

15. A surgical table comprising:
a base;
a column extending from the base along a column axis;
a plurality of body support sections arranged at an end of the column; and
a leg accessory removably attachable to a receptacle block in at least one of the column or the plurality of body support sections, including,
a latching mechanism for selectively latching and unlatching a leg accessory of a surgical table relative to a retaining surface in the surgical table,
interlocking first and second movable components, wherein the first movable component and the second movable component are arranged such that movement of the first movable component in a first direction causes rotation of the second movable component in a second rotational direction;
an actuating device connected to the first movable component such that moving of the actuating device causes movement of the first movable component;
an attachment pin for removably attaching the leg accessory to the surgical table, wherein the attachment pin is connected to the second movable component to rotate as the second movable component rotates, wherein the attachment pin includes an engagement surface moveable between a first position and a second position in response to rotation of the attachment pin, for respectively engaging and disengaging the retaining surface in the surgical table; and
a biasing member configured to bias the attachment pin including the engagement surface thereof toward the first position, wherein the actuating device is movable against the bias of the biasing member to move the attachment pin and engagement surface thereof from the first position to the second position.

16. (canceled)

17. The surgical table of claim 15, wherein the second movable component is arranged such that linear movement of the first movable component in a first direction causes rotation of the second movable component in a second rotational direction, and wherein the actuating device is connected to the first movable component such that linear movement of the actuating device causes corresponding linear movement of the first movable component.

18. The surgical table of claim 15, wherein the second movable component is arranged such that rotational movement of the first movable component in a first direction causes rotation of the second movable component in a second rotational direction opposite the first rotational direction, and wherein the actuating device is connected to the first movable component such that pivoting of the actuating device causes rotation of the first movable component.

19. The surgical table of claim 15, wherein the first movable component includes a pin, wherein the second movable component includes a notch therein, wherein the pin and the notch are configured such that movement of the first and second movable components causes the pin to move radially in the notch relative to a rotation axis of the second movable component.

20. The surgical table of claim 15, further comprising a housing including:
a housing body with a recess shaped to support the first movable component and the second movable component; and
a cover to cover the housing body and to retain the first movable component and the second movable component in the housing body.

21. The surgical table of claim 20, wherein the actuating lever is connected to the first movable component by a drive shaft, wherein the drive shaft extends through an aperture in the cover such that the actuating lever can be arranged on an opposing side of the cover as the first movable component,
wherein the attachment pin is connected to the second movable component by a mechanical latch shaft that extends through an opening in the housing.
